(19) United States
(12) Patent Application Publication
(10) Pub. No.: US 2010/0098276 A1
(43) Pub. Date: Apr. 22, 2010

(54) Hearing Apparatus Controlled by a Perceptive Model and Corresponding Method

(76) Inventors: Matthias Fröhlich, Erlangen (DE); Matthias Latzel, Eggolsheim (DE); Henning Puder, Erlangen (DE); Andre Steinbuss, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/516,861

(22) PCT Filed: Jul. 10, 2008
(86) PCT No.: PCT/EP08/58960

§ 371 Date: May 29, 2009

(30) Foreign Application Priority Data
Jul. 27, 2007 (DE) 10 2007 035 174.9

(51) Int. Cl. H04R 25/00

(52) U.S. Cl. 381/314; 381/317

(57) ABSTRACT

A hearing device including a signal processing device for processing an input signal and generating an output signal and a modeling device in which a perceptive model is implemented, in order to generate a psycho-acoustic value for controlling the signal processing device, is provided. Data mapping of the hearing loss, in particular audiogram data, are input into the modeling device and the perceptive model determines the psycho-acoustic value for controlling the signal processing device based on the data from the data mapping and the output signal.

### CROSS REFERENCE TO RELATED APPLICATIONS

This application is the US National Stage of International Application No. PCT/EP2008/058960, filed Jul. 10, 2008 and claims the benefit thereof. The International Application claims the benefits of German application No. 10 2007 035 174.9 DE filed Jul. 27, 2007, both of the applications are incorporated by reference herein in their entirety.

### FIELD OF INVENTION

The present invention relates to a hearing apparatus with a signal processing device for processing an input signal to an output signal and to a modeling device in which a perceptive model is implemented in order to generate a psycho acoustic value for controlling the signal processing device. In addition the present method relates to a corresponding method for operating a hearing device. The term hearing apparatus is to be understood here especially as a device able to be worn on the ear, such as a hearing device, a headset, headphones and the like.

### BACKGROUND OF INVENTION

Hearing devices are wearable hearing apparatus used to provide assistance those with impaired hearing. To meet the numerous individual requirements different designs of hearing device are provided, such as behind-the-ear (BTE) hearing devices, receiver-in-the-canal (RIC) hearing devices, in-the-ear (ITE) hearing devices and also Concha or in-canal (ITE, CIC) hearing aids. The typical configurations of hearing aid are worn on the outer ear or in the auditory canal. Above and beyond these designs however there are also bone conduction hearing aids, implantable or vibro-tactile hearing aids available on the market. In such hearing aids the damaged hearing is simulated either mechanically or electrically.

Hearing devices principally have as their main components an input converter, an amplifier and an output converter. The input converter is as a rule a sound receiver, e.g. a microphone, and/or an electromagnetic receiver, e.g. an induction coil. The output converter is mostly implemented as an electro acoustic converter, e.g. a miniature loudspeaker or as an electromechanical converter, e.g. bone conduction earpiece. The amplifier is usually integrated into a signal processing unit. This basic structure is shown in FIG. 1, using a behind-the-ear hearing device as an example. One or more microphones 2 for recording the sound from the surroundings are built into a hearing device housing 1 worn behind the ear. A signal processing unit 3, which is also integrated into the hearing device housing 1, processes the microphone signals and amplifies them. The output signal of the signal processing unit 3 is transmitted to a loudspeaker or earpiece 4 which outputs an acoustic signal. The sound is transmitted, if necessary via a sound tube, which is fixed with an otoplastic in the auditory canal, to the hearing device wearer's eardrum. The power is supplied to the hearing device and especially to the signal processing unit 3 by a battery 5 also integrated into the hearing device housing 1.

The essence of hearing device supply makes provision for preconfiguring the hearing system to be adjusted on the basis of the hearing loss. The subsequent course of hearing device adaptation is characterized by fine adaptation steps based on the empirical experience of the hearing aid wearer. Depending on the situation described, the hearing aid acoustician then attempts to transfer the subjective hearing impressions of the subject with impaired hearing to technical parameters of the hearing system. As a rule it is not possible however to design the parameterization of a hearing system such that the hearing system meets the individual requirements of the person with impaired hearing under all circumstances.

Previously a very wide variety of measures have been employed for adjusting hearing devices. Thus for example potentiometers have been used on hearing systems with which the person with impaired hearing has the opportunity of automatically adjusting a psycho acoustic dimension (loudness) depending on the situation. In addition the use of so-called multi-memory devices is also known which give the hearing device wearer the opportunity of loading an alternative configuration of the hearing system depending on the acoustic situation. However classifiers can also be implemented in the hearing system which classify the acoustic environment and adjust the parameterization of the hearing system automatically on the basis of the logic predetermined by the manufacturer. In addition learning hearing devices are also known which automatically adjust their parameterization on the basis of user changes within the framework of predetermined tolerances.

The publication US 2002/0111745 A1 also discloses a wearable hearing analysis system. In this system parameters of a hearing response can be obtained by audiometers. A response prediction is used to make a basic setting of the hearing device.

Furthermore publication EP 0 661 905 A2 describes a generic method for adjusting a hearing device and a corresponding hearing device. With a perceptive model a psycho acoustic variable, especially the loudness, is obtained one the one hand for a normal group of people and on the other for a single individual. Based on the difference between the two psycho acoustic variables, control settings are determined with which the signal transmission to a hearing device is conceived or set ex-situ or is managed in-situ.

From publication DE 103 08 483 A1 a method for automatic amplification adjustment is known. In particular the comprehensibility of speech with a hearing aid device is to be improved. Thus the amplification is adjusted automatically during operation as a function of the signal level and signal frequency determined. In this case amplification parameters are determined by including a loudness model as well as a speech comprehensibility model.

### SUMMARY OF INVENTION

The object of the present invention is to design the adjustment of a hearing device to be as simple as possible and to propose a corresponding hearing device as well as a method relating thereto.

Inventively this object is achieved by a hearing device with a signal processing device for processing an input signal into an output signal, a modeling device in which a perceptive model is implemented, by a psycho acoustic value for controlling the signal processing device, with data mapping a hearing loss being able to be entered into the modeling device and the perceptive model obtaining from the data and the output signal the psycho acoustic value for the control of the signal processing device. The data that maps a hearing loss can in particular be audiogram data.

Furthermore the invention makes provision for a method for operating a hearing device by processing an input signal to the output signal in the hearing device, obtaining a psycho acoustic value with the aid of a perceptive model and controlling or regulating the processing of the input signal based on the psycho acoustic value, with the perceptive model obtaining the psycho acoustic value for the control or regulation of the processing from data mapping a hearing loss, especially audiogram data, and the output signal of the hearing device.

In an advantageous manner it is thus possible to determine nominal values of a hearing impairment with a psycho acoustic model which controls or regulates signal processing.

Preferably the modeling device for generating the control signal contains level information and/or classification information relating to the input signal. This allows parameters to be set for the perceptive model in accordance with the current hearing situation. The signal processing can thus be parameterized in an advantageous manner in interaction with the psycho acoustic model.

The output signal of the signal processing device can be transmitted indirectly via an earpiece and a probe microphone of the hearing device to the modeling device. In this manner the transmission function of the earpiece or loudspeaker of the hearing device can also be taken into consideration for the control of the signal processing device. Alternatively the acoustic output signal of the hearing device can be modeled in a suitable manner and fed to the psycho acoustic model in digital form.

In particular the psycho acoustic value can relate to the loudness, pleasantness, stridency, throatiness or listening effort. Basically any other psycho acoustic dimensions for adjusting or controlling the hearing device can also be included.

Of a special advantage is the constant correction of one or more parameters of the signal processing device by the modeling device. This enables the hearing device to be constantly individually adjusted to the current hearing situation. In this case the parameter or number of parameters relates to the amplification, the compression, the directional microphone characteristics or the interference suppression of the hearing device for example.

A further embodiment to be highlighted in particular consists of a number of psycho acoustic values being obtained with the modeling device and compared in each case with setpoint values, and subsequently the corresponding and different values being assembled weighted into an error variable, with the signal processing device being controlled or regulated such that the error variable is minimized. In this way a multi-dimensional space of psycho acoustic valuables will be used for controlling or regulating the hearing device. In this case the setpoint values can be modified via a potentiometer of the hearing device or via a remote control of the hearing device by the user. Alternatively the setpoint values will be predetermined by the audiologist, if necessary in multi-program devices as well.

### BRIEF DESCRIPTION OF THE DRAWINGS

The present invention is explained in greater detail on the basis of the enclosed drawings, in which the figures show:

FIG. 1 the basic structure of a hearing device according to the prior art und

FIG. 2 a block circuit diagram of an inventive hearing device.

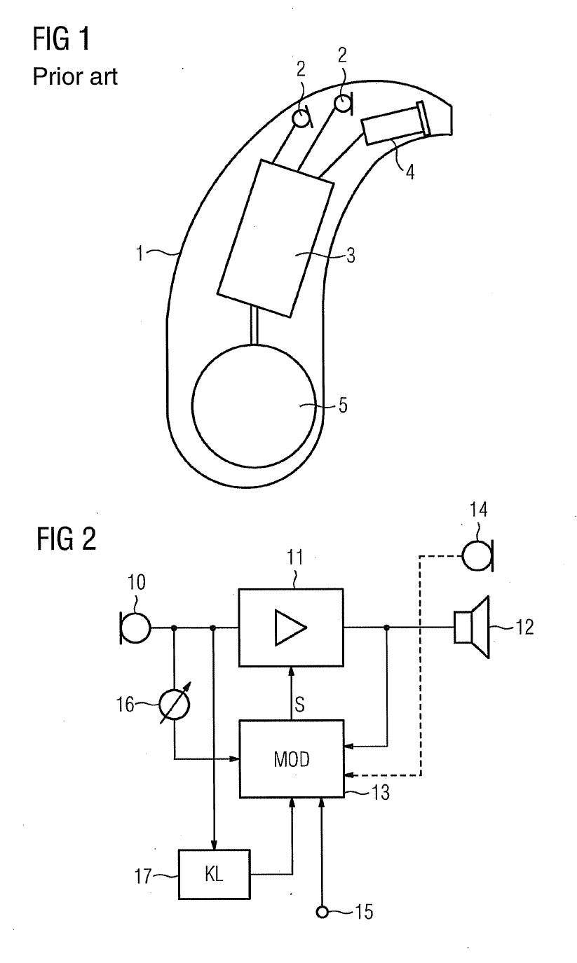

### DETAILED DESCRIPTION OF INVENTION

The exemplary embodiments explained in more detail below represent preferred forms of embodiment of the present invention.

In accordance with the example depicted in FIG. 2 an inventive hearing device is equipped with a least one microphone 10 which delivers an input signal for a signal processing unit 11. The output signal of the signal processing unit 11 is fed to a loudspeaker or to earpiece 12. The signal processing unit 11 is able to be parameterized in the known away in respect of amplification, filtering etc. The parameterization or programming is undertaken for example within the framework of an adjustment. In the present example a modeling device 13 is used for automatic parameterization of the signal processing unit 11. The modeling device 13 possesses a perceptive model which will be explained in greater detail below. Basically the perceptive model serves to convert the output signal of the hearing device into a subjective perception dimension (e.g. loudness). This psycho acoustic variable is then used to control the signal processing unit 11. In the simplest case the output signal of the signal processing unit will thus be tapped and made available to the modeling device 13. In this case however the transmission function of the earpiece 12 is not considered. In a first approximation of the transmission function of the earpiece and the subsequent acoustic coupling can be modeled. If one likewise wishes to take account of this transmission function in obtaining the psycho acoustic variable, then a probe microphone 14 must be introduced into the ear canal for the measurement, in order to measure exactly the actual sound situation in front of the ear drum. The alternate tapping-off of the output signal is shown by a dashed line in FIG. 2.

The probe microphone 14 can also be used to adjust the simple tapping off of the output signal of the signal processing unit 11 to a certain extent. A one-off measurement with the probe microphone is sufficient for this purpose so that the difference between two taps is established and can be taken into consideration with the model of the modeling device. A further processing can subsequently be undertaken with this corrected model without further use of the probe microphone 14.

The perceptive model in the modeling device 13 is individualized by the hearing loss, e.g. described by the audiogram of the person with impaired hearing, being made available via a programming socket 15 of the modeling device 13. The modeling device 13 now generates, on the basis of the perceptive model and the audiogram based on the output signal of the signal processing unit 11 or the probe microphone 14, a control signal S for the signal processing unit 11, so that the latter will be parameterized accordingly.

Optionally there can be provision for the modeling device 13 to be supplied by a level meter 16 with a level signal from the input signal of the signal processing unit 11. Alternatively or in addition a classifier 17 classifies the input signal and supplies the modeling device 13 with a corresponding classification signal. With the input signal and/or the classification signal a differentiated control signal S is able to be obtained by the modeling device 13. Alternatively the signals of the optional level meter 16 or of the optional classifier are fed to the signal processing unit 11 instead of to the modeling device 13.

Thus the problem set down above of simplified adjustment of a hearing device or of a hearing aid is resolved in that, in addition to the wide variety of algorithms on the chip of a hearing device, a single perceptive model of a hearing impairment is implemented. The computing effort for the modeling is thus lower, which also allows the circuit depicted by way of example in FIG. 2 to be implemented in a hearing device, which is barely possible with the method in accordance with the cited publication EP 0 661 905 A2.

Perceptive models which are also suitable for implementation are already known for example under the names “PEMO-Q, PHAQM, MCHI”. The necessary variables for a processing of the models are as a rule specifications about the hearing loss (tone-audiometric hearing loss) as well as an “audio stream”, i.e. an earpiece output.

On the basis of this data perceptive models thus deliver specifications about psycho acoustic dimensions such as for example loudness, pleasantness, stridency and throatiness. In addition further psycho acoustic variables are also conceivable such as for example listening effort, subjective speech comprehensibly or transmission quality.

With the perceptive model implemented on the output side a number of psycho acoustic characteristic values can also be obtained from the audio stream in conjunction with the tone-audiometric hearing loss. If one of these characteristic values falls below a previously defined measure the parameters of the hearing system are automatically adjusted so that the value does not fall below the defined minimum measure, for example for loudness. In a similar way to this example the further said psycho acoustic characteristic values can be optimized automatically by parameters such as amplification, compression, directional characteristic, noise suppression etc. being automatically corrected. The number of parameters to be corrected is not necessarily restricted in such cases.

In accordance with a further developed exemplary embodiment an optimization of a group of selected characteristic values is constantly undertaken and the parameters are accordingly adaptively adjusted in an ongoing manner. Thus for example the loudness is held in a predetermined adjustment range. This is for example possible by constructing a common error function from the weighted characteristic values in accordance with the equation shown below:

error(t)=g1*(LH(t)−LH_opt)̂2−g2*(HA(t)−HA_opt)+g3* . . .

Where the abbreviations have the following meanings:
LH, LH_opt: Loudness or optimal loudness (1^{st} characteristic value)
HA, HA_opt: Listening effort of optimal listening effort (2^{nd} characteristic value)
g1, g2, g3, . . . individual weighting of the amount of these characteristic values for the overall error
(t) : current time

The aim is now, based on the minimization of this error function, to constantly adaptively correct the parameters to be optimized (amplification, compression, directional microphone, interference noise suppression etc). The importance of the characteristic values in the optimization can be taken into account with the weighting. In the special case that only one characteristic value is to be optimized, its weight is set to one and the other characteristic values are set to zero. The sum of all weights then always produces the value 1.

If an analytical description of the characteristic values exists as a function of the parameters to be optimized, known optimization processes (e.g. LKS, RLS.) can be used directly, which use derivations of the characteristic values in accordance with the parameters to be optimized. Otherwise the error can also be determined directly for each parameter from closely adjoining values and thus the direction of the preferred parameter modification can be determined.

The inventive adjustment can also be undertaken with multi-memory devices. In this case different programs of a hearing device can be set up such that in the basic program the psycho acoustic dimension “pleasantness” is maximized and in a further program another dimension such as “listening effort” is minimized. In this case it is not necessary to load other programs in each case but only to adjust the parameterization of the psycho acoustic control unit. The user can in this example switch between the different operating modes via a suitable control element, such as for example a pushbutton on the hearing system, a remote control, voice control etc.

The operating modes can also be switched over automatically. To this end the hearing device must be trained for a certain period for the switchover behavior of the hearing device wearer in different operating modes such as “listening effort” example, with the hearing device additionally registering certain characteristics of the input signal (e.g. level, degree of modulation, pitch, forms . . . ) at the switchover times and thus linking the switchover behavior with the characteristic of the input signal. With the learning function trained in this way the hearing device can automatically switch over the operating modes after a learning period as a function of the input signal and the requirements of the hearing device wearer.

In addition to switching between discrete modes of operation it is further conceivable to correct threshold values relating to the psycho acoustic parameters via a potentiometer or a remote control in finer granularity. These threshold values can on the one hand be set directly by the user using a suitable input medium or can be automatically corrected individually using a learning algorithm.

In accordance with the further exemplary embodiments it is possible, for the correction of the parameterization of the hearing system, to include further characteristic values as has already been indicated above in conjunction with FIG. 2. Thus for example the current classified acoustic situation can be used for the correction. In particular in a situation of “speech in interference noise” detected, the weighting can be biased more heavily in the direction of minimum listening effort, whereas in the hearing situation “music” the optimization in respect of maximum sound quality is the priority.

Furthermore a history of the acoustic situation can be included from data logging for correcting the parameterization of the hearing system.

In the above example of the inventive method is implemented in a hearing device. It is however also conceivable to implement the method with a further device, with which the necessary data will be exchanged. In addition to a wired solution data can also be exchanged wirelessly if required.

Thus with the present invention an automatic control of a hearing system is possible via psycho acoustic characteristic values and not on the basis of statistically pre-optimized settings of a situation detection unit. This produces a number of advantages. On the one hand a basic setting of the hearing systems based on a prescriptive adjustment formula is dispensed with since the hearing system or the hearing device corrects all parameters adaptively in order to optimize the result of the perceptive model. Over and above this is the hearing system pursues the objective of compensating for individual hearing loss in the optimum manner, whereas previous pre-optimized approaches only provide an averagely satisfactory solution. In principle the use of the present invention would also be conceivable for those with normal hearing so that for example they could profit from adaptive hearing protection in loud or acoustically difficult environments.

1.-17. (canceled)

18. A hearing device, comprising:
a signal processing device, that processes an input signal and that produces an output signal; and
a modeling device, that implements a perceptive model which generates a psycho acoustic value, the modeling device uses the psycho acoustic value to control the signal processing device using a control signal,
wherein a data mapping of a hearing loss is entered into the modeling device, and
wherein the perceptive model uses a data from the data mapping and the output signal to obtain the psycho acoustic value for the control of the signal processing device.

19. The hearing device as claimed in claim 18, wherein the data mapping of the hearing loss comprises an audiogram data.

20. The hearing device as claimed in claim 18,
wherein the modeling device obtains a level signal and/or a classification signal relating to the input signal, and
wherein the modeling device uses the level signal and/or classification signal to generate the control signal.

21. The hearing device as claimed in claim 18, wherein the output signal of the signal processing device is transmitted indirectly via an earpiece and a probe microphone of the hearing device to the modeling device.

22. The hearing device as claimed in claim 18, wherein the psycho acoustic value relates to a loudness, a pleasantness, a stridency, a throatiness or a listening effort.

23. The hearing device as claimed in claim 18, wherein a plurality of parameters of the signal processing device are continually corrected by the modeling device.

24. The hearing device as claimed in claim 23, wherein a first parameter relates to an amplification, a second parameter relates to the compression, a third parameter relates to a directional microphone characteristic or a fourth parameter relates to a noise suppression of the hearing device.

25. The hearing device as claimed in claim 18,
wherein a plurality of psycho acoustic values are obtained from the modeling device and each different psycho acoustic value is compared with a setpoint value, and subsequently a corresponding difference value is weighted and compiled into an error variable, and
wherein the signal processing device is regulated so that the error variable is minimized.

26. The hearing device as claimed in claim 18, wherein the plurality of setpoint values are modified via a potentiometer of the hearing device or a remote control of the hearing device.

27. A method for operating a hearing device, comprising:
processing an input signal and producing an output signal in the hearing device;
obtaining a psycho acoustic value using a perceptive model; and
regulating the processing of the input signal on the basis of the psycho acoustic value,
wherein the perceptive model obtains a data mapping of a hearing loss and the output signal to generate a psycho acoustic value, the psycho acoustic value is used to control or regulate the processing.

28. The method as claimed in claim 27, wherein the data mapping comprises an audiogram data.

29. The method as claimed in claim 27, wherein a level signal and/or a classification signal relating to the input signal is included to regulate the processing.

30. The method as claimed in claim 27, wherein the output signal is provided indirectly via an earpiece and a probe microphone to the perceptive model.

31. The method as claimed in claim 27, wherein the psycho acoustic value relates to a loudness, a pleasantness, a stridency, a throatiness or a listening effort.

32. The method as claimed in claim 27, wherein a plurality of parameters for the processing are corrected using the psycho acoustic value.

33. The method as claimed in claim 32, wherein a first parameter relates to an amplification of the hearing device, a second parameter relates to a compression of the hearing device, a third parameter relates to a directional microphone characteristic of the hearing device or a fourth parameter relates to a noise suppression of the hearing device.

34. The method as claimed in claim 27,
wherein a plurality of psycho acoustic values are obtained from the modeling device and each different psycho acoustic value is compared with a setpoint value, and subsequently a corresponding difference value is weighted and compiled into an error variable, and
wherein the processing is regulated so that the error variable is minimized.

35. The method as claimed in claim 34, wherein the plurality of setpoint values are modified via a potentiometer of the hearing device or a remote control of the hearing device.
